(19) United States
(12) Patent Application Publication
(10) Pub. No.: US 2003/0089764 A1
(43) Pub. Date: May 15, 2003

(54) Creating counterfeit-resistant self-authenticating documents using cryptographic and biometric techniques

(75) Inventors: William D. Meadow, Jacksonville, FL (US); Randall A. Gordie JR., Jacksonville, FL (US); Sanjay P. Ahuja, Ponte Vedra Beach, FL (US)

Correspondence Address: FOLEY AND LARDNER, SUITE 500, 3000 K STREET NW, WASHINGTON, DC, 20007, US

(73) Assignee: PAYFORMANCE CORPORATION

(21) Appl. No.: 09/987,009

(22) Filed: Nov. 13, 2001

(51) Int. Cl. G06F 17/00

(52) U.S. Cl. 235/375

(57) ABSTRACT

A system and method for creating and verifying physical documents and/or smart cards based upon positively identifying the owner, holder, or presenter of the document by relating to the measurement of biometric data of the individual at the time of document and/or smart card creation and verification. The biometric data that can be included in the creation of the document include retinal scan, face print, fingerprint, voiceprint and DNA profiles, or other viable biometric data set. Also, protected data that includes important information of the document itself that is written on the document, is combined with the biometric data to provide a security data block that is printed on the document. This security data block is decoded by a document verifier when presented by a document presenter, to provide for an enhanced level of document protection and identity protection.

### RELATED APPLICATIONS

This application is related to application Ser. No. 09/859,356, filed May 18, 2001, application Ser. No. 09/901,124, filed Jul. 10, 2001, and application Ser. No. 09/976,056, filed Oct. 15, 2001, each of these applications by the same inventors as this application. The contents of those related applications are incorporated in their entirety herein by reference.

### BACKGROUND OF THE INVENTION

A. Field of the Invention

The invention relates generally to a system and method for creating counterfeit-resistant, self-authenticating documents using cryptographic and biometric techniques.

B. Description of the Related Art

Document authorization systems and methods are becoming more and more important, since document fraud, especially check fraud, amounts to billions of dollars lost per year by banks and retail establishments. One such conventional system is a check authorization system described in U.S. Pat. No. 6,170,744, by Warren S. Lee and William Meadow, which is assigned to Payformance Corporation and which is incorporated in its entirety herein by reference. In the system and method described in U.S. Pat. No. 6,170,744, information is provided on a check by way of a bar code provided on the check, whereby that information is used to verify the check's authenticity.

Certain documents are also authenticated by way of personal information being provided on the document, such as a fingerprint or a photograph of the document owner. When the document is presented by someone for verification, the fingerprint or photograph on the document is compared against the personal attributes of the document presenter, to determine whether or not the document presenter is in fact the document owner.

However, such personal information on the document can easily be forged or altered, to deceive the document verifier into thinking that the document presenter is the document owner when in fact that person is not.

It is desired to provide a self-authenticating method and system for documents other than checks and other types of negotiable documents, and to incorporate biometric information that is unique to the holder of the document into an encoded data block provided within the document, in order to provide a more robust self-authenticating method and system.

### SUMMARY OF THE INVENTION

An object of one or more embodiments of the present invention to provide for positive identification of the individuals participating in the document creation by capturing biometric data at that time for future use during verification.

An object of one or more embodiments of the invention is to provide for authenticating the biometric data that was captured at the time of document creation by cryptographically signing the stored biometric data for future use during verification.

An object of one or more embodiments of the invention is to provide for authenticating the origin of the document by cryptographically signing key elements of the document.

An object of one or more embodiments of the invention is to provide self-authentication of the cryptographic signature(s) at verification time by use of signed, trusted public keys or certificates.

An object of one or more embodiments of the invention is to provide for “trust hierarchies” that can, if compromised, be used to invalidate documents created by the compromised signing keys. “Trust hierarchy” represents a hierarchy of certificate signers that are approving signers below them in the hierarchy. For example, X.509 certificates can be used as a trust hierarchy. Description of X.509 certificates can be found on the Internet at www.ietf.org/html.charters/pkix-charter.html.

An object of one or more embodiments of the invention is to provide a network scheme for delivery of public key data and, optionally, usage information. The network scheme can be the Internet, which can be used to deliver the public key data and the usage information, if so desired, by way of secure web sites and/or secure links.

An object of one or more embodiments of the invention is to provide for context-sensitive data and data formatting within the signed payloads to be included in an n-dimensional (such as traditional 2-D printed barcodes as well as

emerging holographic barcodes) barcode or other such symbol on the surface of the document.

An object of one or more embodiments of the invention is to provide the aforementioned functionality both on printed documents as well as electronic documents such as smart card devices, personal digital assistants (PDAs), and the files contained within those devices.

An object of one or more embodiments of the invention is to provide a challenge-response handshake between a “document issuer” and a “document issue mechanism” to ensure that the “document issuer” is indeed who they appear to be, as well as to prove to the “document issuer” that the “document issue mechanism” has not been tampered with.

An object of one or more embodiments of the invention is to provide a challenge-response handshake between the “document verifier” and the “document verification mechanism” to ensure that the “document verifier” is indeed who they appear to be, as well as to prove to the “document verifier” that the “document verification mechanism” has not been tampered with.

At least one of these objects can be achieved by a method for authenticating a document and a presenter of the document. The method includes a step of obtaining, at a location whereby the document is being presented by the document presenter, information provided on the document that is to be used to authenticate the document, the information being encoded in a particular format. The method also includes a step of decoding the information to obtain first data and second data, the first data corresponding to unencoded data written on the document to be used to verify whether the document has been modified, the second data corresponding to biometric data of the document owner to be used to verify whether the document owner corresponds to the document presenter. The method further includes a step of obtaining biometric data of the document presenter and comparing the biometric data of the document presenter to the second data. The document is authenticated if the second data matches the biometric data of the document presenter and the first data matches the written data obtained from the document.

At least one of these objects can be achieved by a document authentication system. The document authentication system includes a biometric capture unit that is configured to capture biometric information of a document owner. The document authentication system also includes a protected data capture unit that captures protected data of the document owner. The document authentication system further includes a digital signature unit that provides a digital signature of an entity. The document authentication system still further includes a signed data block creation unit that combines the biometric information, the protected data, and encodes the combined data with the digital signature to provide a signed data block. The document authentication system also includes a security data block creation unit that combines the signed data block with a public key of a document issuer to create a biometric security data block. The document authentication system further includes an encoding and output unit that encodes the biometric security data block into a particular format. The encoded biometric security data block is output to the document. The biometric security data block is used by a document verifier to authenticate the document and to authenticate a presenter of the document with respect to the document owner.

At least one of the objects of the invention can be achieved by a secure document creation and authentication system. The secure document creation and authentication system includes a first biometric capture unit that is configured to capture biometric information of a document owner. The system also includes a second biometric capture unit that is configured to capture biometric information of a document presenter. The system further includes a protected data capture unit that captures protected data of the document owner. The system still further includes a digital signature unit that provides a digital signature of a document issuer that issues the secure document to the document owner by using a private key of the document issuer. The system also includes a signed data block creation unit that combines the biometric information of the document owner and the protected data of the document owner, and encodes the combined data with the digital signature to provide a signed data block. The system further includes a security data block creation unit that combines the signed data block with a public key of the document issuer to create a biometric security data block. The system still further includes an encoding and printing unit that encodes the biometric security data block into a particular format and prints the encoded biometric security data block onto the document. The biometric security data block is used by a document verifier to authenticate the document and to authenticate a presenter of the document with respect to the document owner by comparing the biometric information of the document owner obtained from the document with the biometric information of the document presenter as output by the second biometric capture unit.

### BRIEF DESCRIPTION OF THE DRAWINGS

The foregoing advantages and features of the invention will become apparent upon reference to the following detailed description and the accompanying drawings, of which:

FIG. 1 shows the various elements utilized in an authentication scheme according to the present invention;

FIG. 2 shows one possible data layout of a secured data block that is to be encoded and printed onto a document as a bar code, for example, for use in authenticating the document, according to the present invention;

FIG. 3 shows steps in the process for creating a self-authentication secure document with biometric data according to the present invention;

FIG. 4 shows additional steps in the process for creating a self-authentication secure document with biometric data according to the present invention;

FIG. 5 shows steps in the process for authenticating a self-authentication secure document with biometric data according to the present invention;

FIG. 6 shows additional steps in the process for authenticating a self-authentication secure document with biometric data according to the present invention;

FIG. 7 shows more additional steps in the process for authenticating a self-authentication secure document with biometric data according to the present invention; and

FIG. 8 shows still more additional steps in the process for authenticating a self-authentication secure document with biometric data according to the present invention.

DETAILED DESCRIPTION OF THE PREFERRED EMBODIMENTS

Preferred embodiments of the invention will be described in detail below, with reference to the accompanying drawings.

The present invention provides a counterfeit-resistant, self-authenticating document by using cyptographic and biometric techniques, whereby information is provided on the document to be used to authenticate the document as well as the document owner.

For example, the present invention is applicable to providing counterfeit-resistant, self-authenticating passports, whereby encrypted information is provided on the passport, such as by way of a two-dimensional bar code or other type of code printed or otherwise firmly affixed to the document (so that removal of the bar code cannot be done without causing visible damage to the document). The encrypted information is used in a document and document presenter authentication process.

When the passport is provided to an official, such as an airline ticket counter agent at an airport, the bar code information is read by the official using a bar code scanner or the like, and the information is decoded by a decoding mechanism coupled to the scanner. The decoded information is provided to the airline official in a convenient manner. For example, it can be provided in textual form on a display of a computer monitor coupled to the decoding mechanism.

The information from the bar code is then compared against the written information on the passport itself, to determine if any fraudulent modifications have been made to the passport. For example, the name, date of birth, and country of citizenship information can be encoded onto the bar code, and that information is read by the bar code scanner, decoded, and provided on a display for the airline official to review. The airline official then compares that information to the actual information that is written on the passport. If there are any discrepancies, the passport is considered to be fraudulent.

Additionally, biometric information, such as a digitized photograph of the passport owner, is encoded into a group of bytes of information (e.g., 80-100 bytes), and is also stored as information in a bar code that is printed on or otherwise firmly affixed to the passport. In a manner known to those skilled in the art, the photograph on the passport can be scanned, to obtain a .tiff file or other image format, which can be compared to the information that is encoded on the bar code, to determine if the photograph on the passport is genuine or has been changed in any measurable way. That way, by way of the present invention, not only can the written information on a document be authenticated. but also biometric information that is used to verify that the document presenter is the document owner can be authenticated.

The present invention provides a system and a method for creating and verifying physical documents and/or smart cards and/or PDAs based upon positively identifying the owner, holder, or presenter of the document by means relating to the measurement of the physical characteristics of the individual at the time of document and/or smart card and/or PDA creation and verification. By way of example and not by way of limitation, a few examples of the types of biometric data that can be included in the creation of the document include retinal scan, face print, fingerprint, voiceprint, and DNA profiles. This is done in the present invention in conjunction with state-of-the-art cryptographic techniques to provide for a high level of document and identity protection.

The present invention can be utilized for protecting documents such as, but not limited to, passports, visas, driver licenses, hazardous material licenses, employee ID cards at secure facilities and pilot licenses, just to mention a few. The aforementioned documents are intended to be unique to a single individual and form the basis of trust for a multitude of public and private facilities worldwide. However, they are relatively simple to counterfeit by someone skilled in the art. On the other hand, there exists a plethora of document security features, which can be added to the document, including holograms, security paper and barcodes. Unfortunately, no single one of these techniques, or even a combination thereof, is capable of removing the ability to create counterfeit documents from the reach of the criminals or terrorists.

The present invention provides a system and a method by which the authenticity of the document as well as those participants involved in its creation of the document can be positively identified, whereby the ability to create a counterfeit document is removed from the hands of would-be counterfeiters without significant assistance from insiders using detailed crypanalysis and unrestricted access to an implementation of this technology.

The present invention relies upon public key cryptography (PKC) and public key infrastructure (PKI) technologies to provide the non-repudiation and binding trust relationships necessary to authenticate the creation parameters of documents via such mechanisms as digital signatures and signing certificates. Such technologies are known to those skilled in the art. For example, information on these technologies can be found in “A Public-Key Cryptosystem and a Signature Scheme Based on Discrete Logarithms”, by Taher Elgamal, published in IEEE Transactions on Information Theory, v. IT-3, n. 4, 1985, pages 469-472, or in “Advances in Cryptology—CRYPTO '84”, pages 10-18, Springer-Velag, 1985. Also, information on these technologies can be obtained from the Internet, such as on www.ietf.org/html.charters/pkix-charter.html.

The process of “digitally signing” data via cryptographic techniques is well known to those skilled in the art. The essence of these techniques is that the data that is “signed” is bound to the created “signature” and any changes to either component will invalidate both. Information on digital signatures can be found, for example, on the Internet, at www.itl.nist.gov/fipspubs/fip186.htm.

The present invention also incorporates biometric data capture and storage to facilitate the positive identification of individuals involved in the document creation, including the document owner and the document issuer.

Current biometric identification techniques are sophisticated enough to provide a much needed component of the present invention, namely, the ability to uniquely identify an individual by physical means that requires their presence at document creation and at document verification times.

In order to simplify the following descriptions and drawings provided in this application, the following general requirements and assumptions are stated to be in effect unless otherwise stated.

The term “document” represents an object that contains variable data and is to be secured using the system and method of the present invention. “Documents” can be of a variable media type. For example, a document can be a video or audio file, or a standard data file.

The term “media type” represents the physical manifestation of a “document”. For instance, a “document” can be a physical piece of paper, or a plastic smart card, or even a file contained within a PDA.

The term “document issuer” represents the individual that is preparing the document as a service to the “document owner”. The “document issuer” is bound to a public/private key pair and is responsible for securing their “private signing key”.

The term “document issue mechanism” represents the physical device(s) and software necessary to create a secured document.

The term “secured document” represents a document that has been created by a “document issue mechanism” and therefore contains a “secured data block”.

The term “document owner” represents the individual for whom the document is being prepared. This individual's biometric profile is bound to the document at the time the document is created. More than one biometric profile of the individual can be bound to the document, to provide a more robust authentication.

The term “bound document data” represents certain elements of a document that are digitally signed and therefore protected against tampering.

The term “private signing key” represents the private portion of a cryptographic public/private key pair. It is important to any cryptographic system that the private keys are kept secure.

The term “public signing key” represents the public portion of a cryptographic public/private key pair. In the context of this description, the public signing key is understood to have been signed, and is therefore trusted, by a higher authority capable of delegating signing authority to “document issuers”. This is the basis of “trust hierarchies”.

The term “document presenter” represents an individual who possesses a document created by way of the present invention and who is presenting it for validation to a “document verifier”. It is important to note that the “document presenter” may not necessarily be the “document owner”, in which case, the “document presenter” is a possible counterfeiter.

The term “document verifier” represents an individual that is using the “document verification mechanism” to authenticate a document created by this system along with the identity of the “document presenter” that is presenting this document.

The term “document verification mechanism” represents the physical device(s) and software necessary to verify a secured document.

The term “secured data block” represents the combination of “bound document data”, “public signing key” (also called “trusted signing key” herein) and “digital signature” of the “bound document data”.

The term “identity template” or “biometric profile” represents the unique signature of an individual that has been measured by a “biometric data capture device”.

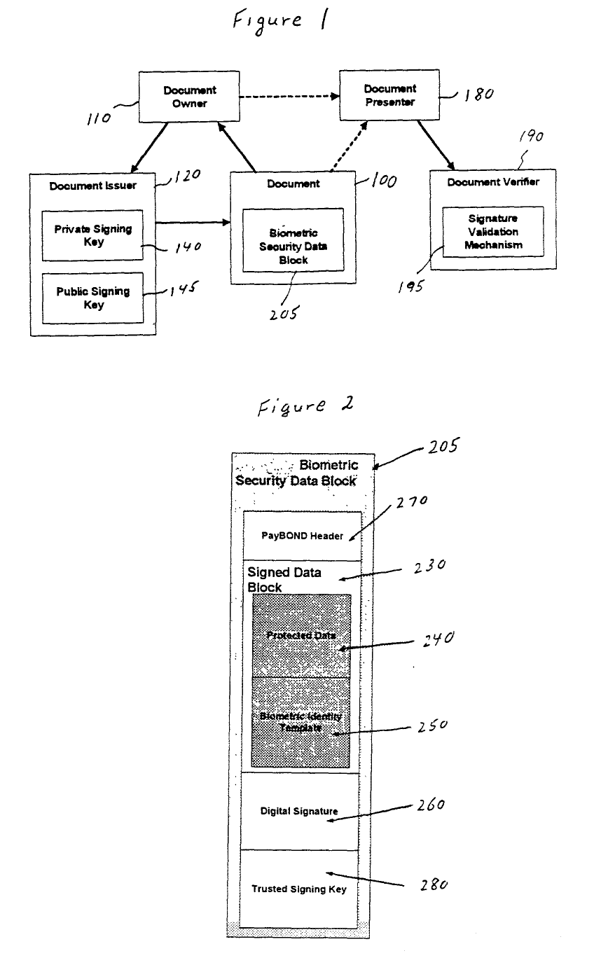

The creation of a counterfeit-resistant, self-authenticating document 100 in accordance with a first embodiment of the invention will be explained below, which reference to FIGS. 1, 2, 3 and 4.

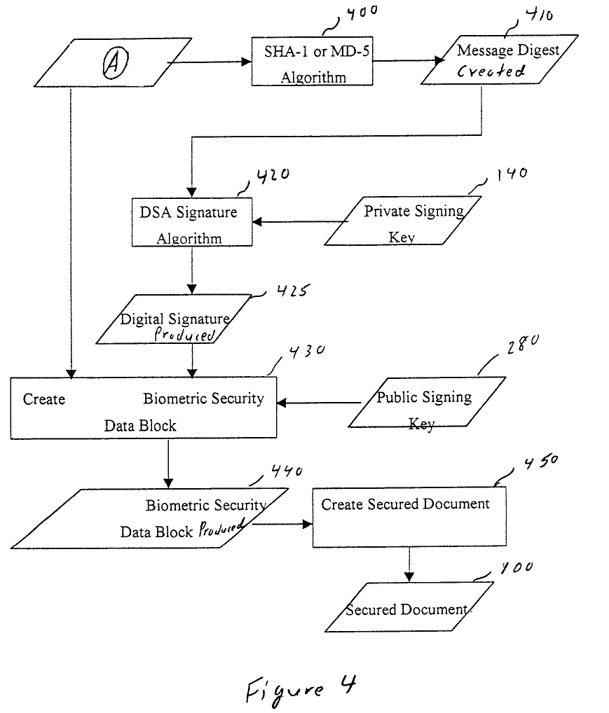

Biometric data is captured from the document owner 110 by the document issuer 120 utilizing a biometric data capture device (see step 300 in FIG. 3). For example, the biometric data capture device may correspond to a retinal scan device that obtains an imprint of a retina of the document owner 110, whereby the imprint is digitized into a sequence of data bits that represent a pictorial representation (e.g., pixels in a matrix) of the retina. Alternatively, a fingerprint scanner can be used to scan information from one or more fingers of the document owner 110. Alternatively, a photograph of the document owner 110 is taken, which is converted to digital form. Other types of biometric data that can be used have been described previously (such as DNA profile, voice print, etc.).

Next, the biometric data is analyzed to create a biometric identity template 250, as shown in step 310 in FIG. 3. This analysis may be as simple as digitizing the biometric data and storing it into a data file in a particular format. For example, if a photograph is taken of the document owner 110, whereby the photograph is to be placed on the document 100 during the document creation process (preferably in such a manner that the photograph cannot be removed without causing noticeable damage to the document 100 itself), the photograph is digitized into a sequence of bits (e.g., 80 to 100 bytes of data) and then stored in the form of a data file. In a preferred implementation, the biometric identity template 250 contains data that is context-sensitive within the scope of a given type of biometric capture.

Next, the bound document data, or protected data 240, is collected, as shown in step 320 in FIG. 3. The protected data 240 contains any data that is to be digitally signed and bound to the document. By way of example and not by way of limitation, the protected data 240 may include the name, home address and/or citizenship information of a passport owner, for example.

Also, in a second embodiment of the invention, a personal key known to the document owner 110 (and not typically known by others), such as the maiden name of the document owner's mother, can be collected by the document issuer 120 during the document creation process and stored as part of the protected data 240.

Next, the protected data 240 and the biometric data 250 are packed into a contiguous signed data block 230, as shown in steps 330 and 340 in FIG. 3. The signing of the data block 230 is preferably done by generating a digital signature 260 by using the private signing key 140 of the document issuer 120. In one embodiment, the protected data 240 is stored as a first part of a data sequence in the signed data block 230, and the biometric data 250 is stored as a second part of a data sequence in the signed data block 230, with a delimiter preferably provided therebetween to be used to separate these two parts when the document is to be authenticated. The order can be switched in a different configuration.

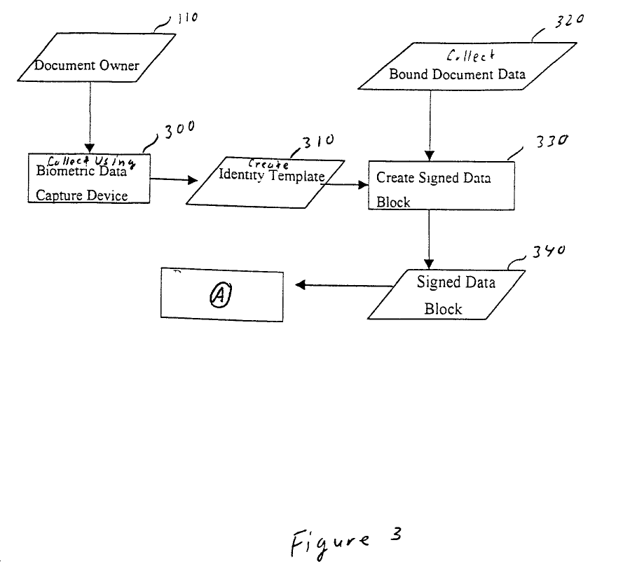

The digital signature 260 can be provided at the beginning or the end of the packed data, or at any known location so that it can be recovered when the document is to be authenticated. FIG. 2 shows the digital signature 260 provided at the end of the signed data block 230.

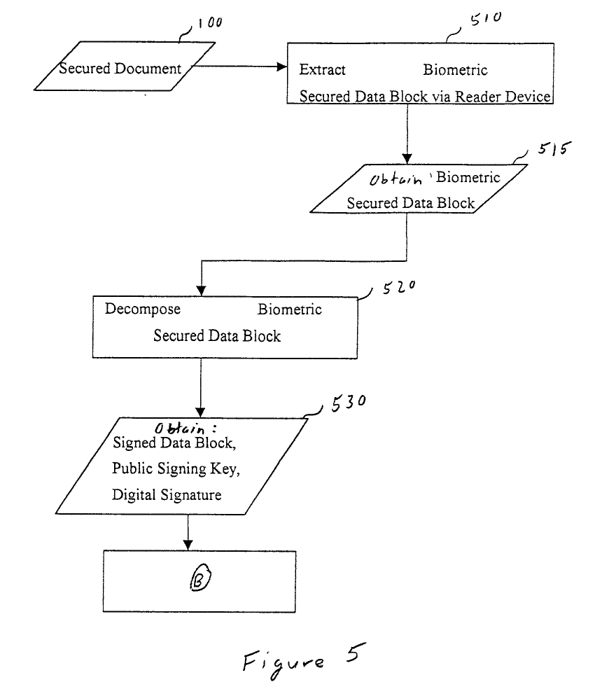

Next, the signed data block 230 is digested using a cryptographic message digest mechanism such as SHA-1, or MD-5, or by another cryptographic algorithm that is known to those skilled in the art, as shown in step 400 in FIG. 4, to thereby create a unique message digest, as shown in step 410. For example, please refer to the related patent applications which describe various cryptographic processes in detail.

A digital signature algorithm, such as DSA or other suitable algorithm (e.g., El Gamel algorithm), is performed, as shown in step 420, to produce the digital signature 260, and consumes the message digest while using the private signing key 140 as a necessary input (primer) for the cryptographic signing operation. The producing of the digital signature is shown in step 425.

As explained above, the contiguous signed data block 230 is subjected to a cryptographic algorithm, and then the digital signature 260 is appended to that data.

Next, the digital signature 260 (as produced from step 425), a trusted signing key 280 and the signed data block 230 are packed to create a biometric secured data block 205. The creation of the biometric secured data block is shown as steps 430 and 440 in FIG. 4. The trusted signing key 280 contains the public key 150 of the document issuer 120 that signed the document 100 (and thereby verified that the document 100 was properly created by a proper authority). The trusted signing key 280 is signed by, and therefore trusted to, a signing authority. For example, a passport would be created by a government agency entrusted to do this, whereby a passport issuing official would sign an issued passport by way of the issuing official's trusted signing key 280, which would then be provided as part of the biometric secured data block 205.

As shown in FIG. 1, the document issuer 120 has a private signing key 140 and a public signing key 145 assigned to them, by way of a PKI scheme that is known to those skilled in the art. The private signing key 140 is used by the document issuer to digitally sign the document 100 (to provide the digital signature 260), and the public signing key 145 is included in the trusted signing key 280 portion of the biometric secured data block 205, to be used by the document verifier 190 to authenticate the document 100.

Next, the biometric secured data block 205 is embedded into or onto the document, to create a secured document 100, as shown in step 450, with the type of embedding depending upon the target media type. For example, it can be embedded by way of printing a bar code onto a prominent location on the secured document 100, by using indelible print ink. Alternatively, the bar code can be rigidly affixed (using strong glue or some other permanent affixing means) onto a prominent location on the secured document 100, whereby removal of the bar code would cause visible damage to the document 100 that can be easily seen by someone.

The bar code also preferably includes information from a header portion 270 of the biometric secured data block 205. The header portion 270 contains information describing the contents and exact data layout of the other elements within the bar code data. For example, the header portion 270 includes information concerning the sequence of data blocks, as well as the size of each of the data blocks, and also may include the type of biometric data that is stored in the biometric identity template 250.

Given the fairly large amount of digital information to be embedded, a two-dimensional bar code is preferable for embedding the authentication information (that is, the biometric security data block 205) onto the document 100. However, other types of bar code or other type of print code schemes, such as a hexagonal code scheme utilized by courier companies for tracking packages being shipped, could alternatively be used.

The steps involved in authenticating a document 100 created by way of the first embodiment of the present invention will be described below, with reference to FIGS. 1, 2, 5, 6, 7 and 8.

These steps provide for authenticating of a self-authenticating document 100 as well as matching the document presenter 180 with the identity of the document owner 110. That is, if the document 100 is authentic but the document presenter 180 is determined from the biometric data obtained from the document 100 to not correspond to the document owner 110, then the document verifier 190 determines that the document presenter 180 may be a counterfeiter who has unlawfully obtained the document, and the document verifier 190 can take appropriate steps. For example, the document verifier 190 can subtly notify the police.

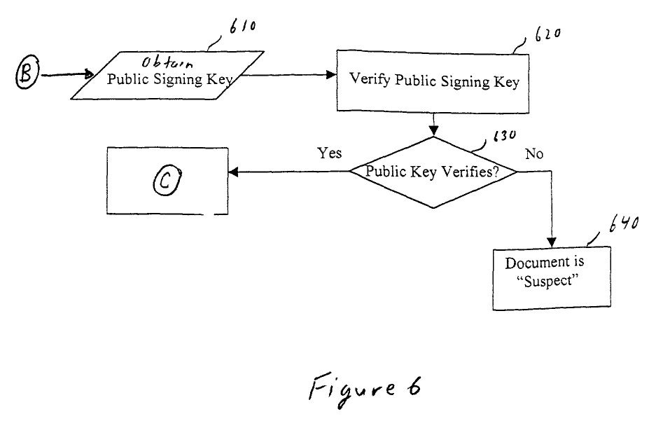

In the authentication process the biometric secured data block 205 is collected from the secured document 100 via an appropriate reader mechanism depending upon the media type of the document 100, as provided in step 510 in FIG. 5. For example, a bar code scanner can be used to scan a bar code on the document 100 that has the biometric secured data block 205 encoded therein.

Next, the biometric secured data block 205 is obtained in step 515. The obtained biometric secured data block 205 is decomposed into a signed data block 230 (in encrypted form), a trusted signing key 280 and a digital signature 260, as shown by steps 520 and 530 in FIG. 5. As explained above, the header information 270 obtained from the scanned and decoded bar code may be used to determine the structure of the data in the bar code, to thereby parse the data into the various component parts.

Next, referring to FIG. 6, the trusted signing key 280 is obtained from the scanned bar code, as shown in step 610. The obtained trusted signing key 280 is then verified against a list of trusted signing keys that are made available to the document verifier 190, as shown in steps 620 and 630. By way of example and not by way of limitation, the document verifier 190 may access this list from a secure Internet site.

If the trusted signing key 280 obtained from the bar code of the document-to-be-authenticated is not trusted at the time of presentment, then the document 100 is marked as “possibly counterfeit” or “suspect”, as shown by step 640. In that case, the document issuer 120 is determined to not be a valid issuer of documents, and the document 100 is not accepted as an authentic document.

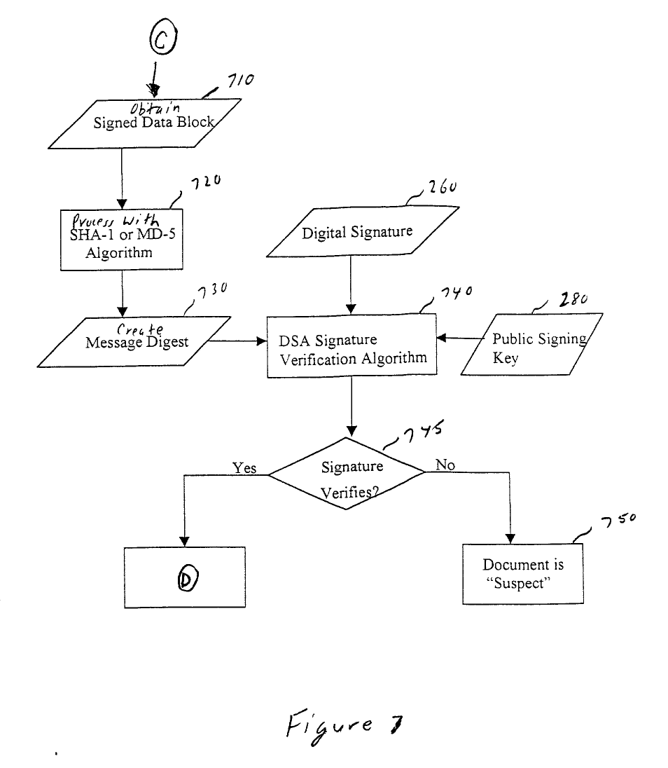

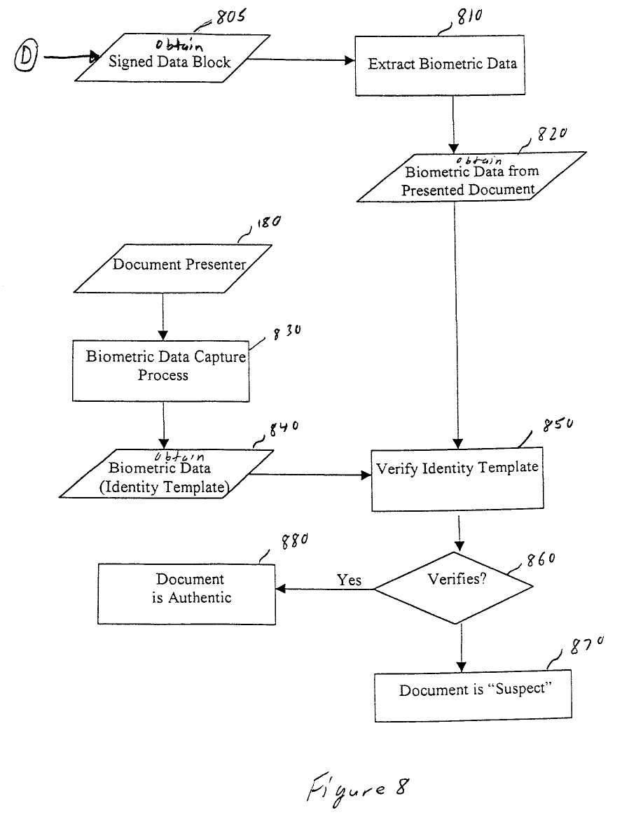

Next, referring now to FIG. 7, if the trusted signing key 180 is verified, a message digest of the signed data block 230 is created, by way of a cyptographic message digest mechanism that is used to obtain the information in the signed data block 230. The signed data block 230 is obtained from the secure document 100 in step 710, and the cryptographic message digest mechanism is used on the signed data block 230, as shown in step 720. As a result, a message digest is obtained, as shown in step 730.

Next, the message digest (that is, the signed data block 230 that has been processed by a cryptographic algorithm), the trusted signing key 280 and the digital signature 260 obtained from the scanned bar code are used to validate the digital signature 260, to thereby confirm whether or not the signed data block 230 has been tampered with. This is the process performed in the verification algorithm shown in steps 740 and 745 in FIG. 7. If it has been tampered with, the document 100 is marked as “suspect” or “fraudulent”, as shown by step 750. A signature validation mechanism 195 is used by the document verifier 190 to perform this validation of the digital signature 260, in a manner known to those skilled in the art.

Next, referring to FIG. 8, if the signatures do verify, the signed data block is obtained as shown in step 805 (which is the same step as step 710 in FIG. 7), the biometric data 250 is extracted from the signed data block 230, as shown in step 810 in FIG. 8, and the type of the biometric data 250 is determined based on its structure and format, as shown in step 820. For example, based on its structure and format (and on information that may be provided in the header portion 270 of the biometric secured data block 205), it is determined whether the biometric data 250 corresponds to a retinal eye scan, a fingerprint scan, a photograph scan. DNA profile, voiceprint, or some other type of biometric data.

Next, the appropriate biometric data capture device is used to obtain biometric information directly from the document presenter 180, in a biometric data capture process, as shown in step 830, to create an identity template of the document presenter 180, as shown in step 840. For example, a retina scan device is used to obtain a retina scan of the document presenter 180, if it is determined that the biometric data 250 corresponds to retina scan data of the document owner 110.

Next, the identity template of the document presenter 180 is matched against the biometric data 250 obtained from the presented document, in a biometric data verification steps 850 and 860 as shown in FIG. 8. If they do not match, then the document is marked as “suspect” (at the very least the document presenter 180 is determined to be not the document owner 110), as shown in step 870 in FIG. 8.

If the document 100 has not been marked as “suspect” throughout the previous steps, then the authenticity of the document 100 and of the document presenter 180 is established, as shown in step 880 in FIG. 8.

The document verification mechanism utilized by the document verifier 190 preferably corresponds to a computer programmed to perform the steps described above with respect to the verification process. The software to perform these steps is preferably stored in the hard drive of the computer, or in a removal media that can be placed into an available drive of the computer, or from a network such as the Internet. The computer preferably is coupled to a display or monitor, to provide information to the document verifier 190. The computer is also coupled to a biometric data collecting device that collects biometric data from the document presenter 180, and which provides the biometric data to the computer to be compared against the biometric data 250 extracted from the document 100.

The document issue mechanism utilized by the document issuer 120 preferably corresponds to a computer programmed to perform the steps described above with respect to the document creation process. The software to perform these steps is preferably stored in the hard drive of the computer, or in a removal media that can be placed into an available drive of the computer, or from a network such as the Internet. The computer preferably is coupled to a display or monitor, to provide information to the document issuer 120. The computer is also coupled to a biometric data collecting device that collects biometric data from the document owner 110, and which provides that biometric data to the computer to be provided in the biometric identity template 250 that is to be included in a bar code to be imprinted or otherwise affixed to the document 100.

In the second embodiment of the invention, personal information known only to the document owner 110 (and perhaps others who know the document owner 110 very well) is included in the protected data 240 of the biometric secured data block 205. With this information provided (on a display) to the document verifier 190, the document verifier 190 can then ask the document presenter 180 to provide this personal information to the document verifier 190. For example, the document presenter 190 can verbally provide the requested personal information to the document verifier 190, or he or she can enter the personal information on a keyboard. This provides an additional level of authentication of the document presenter 180 with respect to whether he or she is in fact the document owner 110.

In a third embodiment of the invention, a challenge-response handshake procedure is used between the document issuer 120 and the document issue mechanism to ensure that the document issuer 120 is indeed who he or she appears to be, as well as to prove to the document issuer 120 that the document issue mechanism has not been tampered with. The document issue mechanism provides the document 100, such as a passport, with a bar code or other type of authentication code imprinted or otherwise affixed thereto, in accordance with the present invention.

In the third embodiment, upon turning on the document issue mechanism, the document issuer 120 types in a password known only to the document issuer 120, to thereby allow access to the document issue mechanism to be able to issue valid documents. The document issuer 120 can request a “dump” of information from the document issue mechanism, such as version number of software stored therein and/or the number of the last issued document, in order that the document issuer 120 can determine whether or not the document issue mechanism has been tampered with.

A similar procedure can be done between the document verifier 190 and the document verifier mechanism used to verify documents that are presented to the document verifier 190, in the third embodiment of the invention. Of course, other types of challenge-response handshake schemes may be utilized by the document issuer 120 and the document verifier 190 to ensure the integrity of the document issuing process and the document verifying process.

Thus, a system and method has been described according to several embodiments of the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A method for authenticating a document and a presenter of the document, comprising:
obtaining, at a location whereby the document is being presented by the document presenter, information provided on the document that is to be used to authenticate the document, the information being encoded in a particular format;
decoding the information to obtain first data and second data, the first data corresponding to unencoded data written on the document to be used to verify whether the document has been modified, the second data corresponding to biometric data of the document owner to be used to verify whether the document owner corresponds to the document presenter; and
obtaining biometric data of the document presenter and comparing the biometric data of the document presenter to the second data,
wherein the document is authenticated if the second data matches the biometric data of the document presenter and the first data matches the written data obtained from the document.

2. The method according to claim 1, wherein biometric data corresponds to at least one of retinal scan data, fingerprint data, voiceprint data, and photographic data, or other viable biometric data set.

3. The method according to claim 1, wherein the decoding step includes the steps of:
obtaining a public key from the decoded information; and
validating the certificate by verifying the digital signature within the certificate that proves the validity of the public key contained therein.

4. The method according to claim 3, wherein the decoding step further includes the steps of:
performing a cryptographic algorithm on the first data and the second data to obtain biometric data of a document owner to be compared against the biometric data obtained from the document presenter.

5. A document authentication system, comprising:
a biometric capture unit that is configured to capture biometric information of a document owner;
a protected data capture unit that captures protected data of the document owner;
a digital signature unit that provides a digital signature of an entity;
a signed data block creation unit that combines the biometric information and the protected data, to provide a signed data block;
a security data block creation unit that combines the signed data block and the digital signature of the signed data block with a public key of a document issuer to create a biometric security data block; and
an encoding and output unit that encodes the biometric security data block into a particular format and outputs the encoded biometric security data block to the document,
wherein the biometric security data block is used by a document verifier to authenticate the document and to authenticate a presenter of the document with respect to the document owner.

6. The system according to claim 5, wherein the particular format is a bar code format.

7. A secure document creation and authentication system, comprising:
a first biometric capture unit that is configured to capture biometric information of a document owner;
a second biometric capture unit that is configured to capture biometric information of a document presenter;
a protected data capture unit that captures protected data of the document owner;
a digital signature unit that provides a digital signature of a document issuer that issues the secure document to the document owner by using a private key of the document issuer;
a signed data block creation unit that combines the biometric information of the document owner and the protected data of the document owner to provide a signed data block;
a security data block creation unit that combines the signed data block and the digital signature of the signed data block with the public key of the document issuer to create a biometric security data block; and
an encoding and output unit that encodes the biometric security data block into a particular format and outputs the encoded biometric security data block to the document,
wherein the biometric security data block is used by a document verifier to authenticate the document and to authenticate a presenter of the document with respect to the document owner by comparing the biometric information of the document owner obtained from the document with the biometric information of the document presenter as output by the second biometric capture unit.

8. The system according to claim 7, wherein the biometric data is at least one of retina eye scan, DNA information, fingerprint information, voiceprint information, and photographic information, or other viable biometric data set.
